(19) United States
(12) Patent Application Publication
(10) Pub. No.: US 2016/0044190 A1
(43) Pub. Date: Feb. 11, 2016

(54) IMAGE PROCESSING SYSTEM

(71) Applicant: KYOCERA Document Solutions Inc., Osaka (JP)

(72) Inventor: Hikaru Miyaji, Osaka (JP)

(21) Appl. No.: 14/817,229

(22) Filed: Aug. 4, 2015

(30) Foreign Application Priority Data
Aug. 6, 2014 (JP) 2014-160343

(51) Int. Cl. H04N 1/00; H04N 1/21

(52) U.S. Cl. CPC H04N 1/00466; H04N 1/21; H04N 1/00244; H04N 1/00092; H04N 1/00076; H04N 1/00082

(57) ABSTRACT

An image processing system has a plurality of image processing apparatuses connected via a network. At least one of the image processing apparatuses includes a storing unit, a determination unit, a retrieving unit, and a notification unit. The storing unit stores data on each of the image processing apparatuses, including data on an optional function included in the apparatus. The determination unit determines whether an image read by an image reading unit has any mark left by processing corresponding to an optional function. In response to determination by the determination unit that the image has the mark, the retrieving unit retrieves from the storing unit the data on the image processing apparatus that includes the optional function corresponding to the mark. The notification unit notifies the data on the image processing apparatus that includes the optional function, retrieved by the retrieving unit.

### INCORPORATION BY REFERENCE

The disclosure of Japanese Patent Application No. 2014-160343 filed on Aug. 6, 2014 including the specification, drawings and abstract is incorporated herein by reference in its entirety.

### BACKGROUND

The present disclosure relates to image processing systems.

In image processing apparatuses typified by a digital multifunctional peripheral and the like, an image of a document is read by an image reading unit and a photoreceptor included in an image forming unit is irradiated with light based on the read image, so an electrostatic latent image is formed on the photoreceptor. A developer such as charged toner is supplied onto the electrostatic latent image to form a visible image, which is transferred and fixed onto a sheet of paper. The sheet is then discharged to the outside of the apparatus.

Some image processing apparatuses perform post-processing on sheets of paper on which images have been formed, by using a stapling function of stapling the sheets together, or a punching function of punching the sheets near the edges thereof Such stapling and punching functions are often included in post-processing devices such as a so-called inline finisher.

Techniques regarding a system equipped with a post-processing device are conventionally known. A typical system equipped with a post-processing device includes a printer having a post-printing processing function, and an information processor directly or indirectly connected to the printer. This system includes: a text print setting input unit configured to perform print setting on a whole or part of a document; a printer post-processing capability obtaining unit configured to obtain post-processing capability of the printer; a post-processing capability comparing unit configured to compare the text print setting with the printer's post-processing capability to determine any inexecutable post-processing capability; and an executable text print setting creating unit configured to create text print setting that can be executed with the printer's post-processing function.

### SUMMARY

In an aspect of the present disclosure, an image processing system has a plurality of image processing apparatuses connected via a network. At least one of the image processing apparatuses includes a storing unit, an image reading unit, a determination unit, a retrieving unit, and a notification unit. The storing unit stores data on each of the image processing apparatuses including data on an optional function included in the image processing apparatus. The image reading unit reads an image of a document. The determination unit determines whether the image read by the image reading unit has any mark left by processing corresponding to an optional function. The retrieving unit is operable, in response to determination by the determination unit that the image has the mark, to retrieve from the storing unit the data on the image processing apparatus that includes the optional function corresponding to the mark. The notification unit notifies the data on the image processing apparatus that includes the optional function, retrieved by the retrieving unit.

### BRIEF DESCRIPTION OF THE DRAWINGS

FIG. 1 schematically shows an appearance of a digital multifunctional peripheral in the case where an image processing apparatus included in an image processing system according to an embodiment of the present disclosure is applied to the digital multifunctional peripheral;

FIG. 2 is a block diagram showing the configuration of the image processing system according to an embodiment of the present disclosure, mainly showing the configuration of the digital multifunctional peripheral shown in FIG. 1;

FIG. 3 is an appearance diagram schematically showing the configuration of an operation unit;

FIG. 4 is a conceptual diagram showing the content of data stored in a hard disk;

FIG. 5 is a flowchart illustrating a process flow in the case where image processing is performed using the image processing system according to an embodiment of the present disclosure;

FIG. 6 shows documents set in an ADF;

FIG. 7 shows an image read by an image reading unit;

FIG. 8 shows, by way of example, a display screen in the operation unit in the case of inquiring whether to use the digital multifunctional peripheral being displayed;

FIG. 9 shows, by way of example, a display screen in the operation unit in the case of prompting a user to input new setting for an optional function;

FIG. 10 shows, by way of example, a display screen in the operation unit on which a user can set to perform image processing of erasing punched hole marks; and

FIG. 11 shows, by way of example, a display screen in the operation unit in the case of causing a user to set the timing of output.

### DETAILED DESCRIPTION

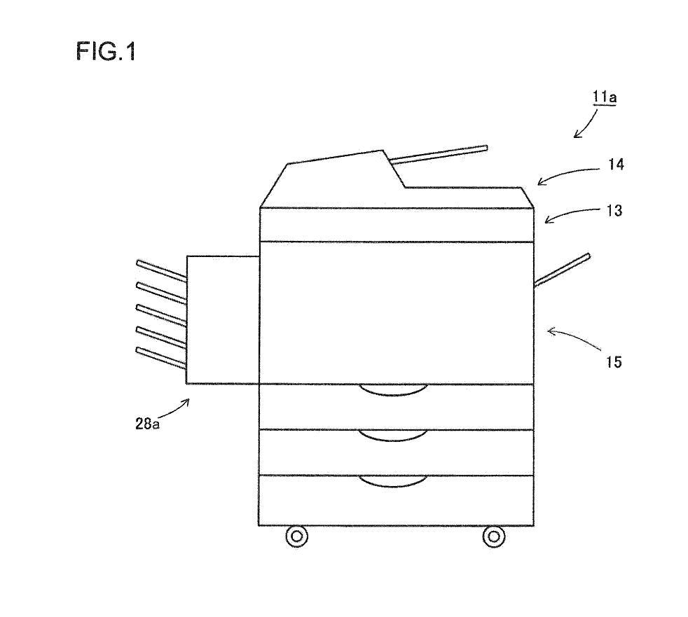

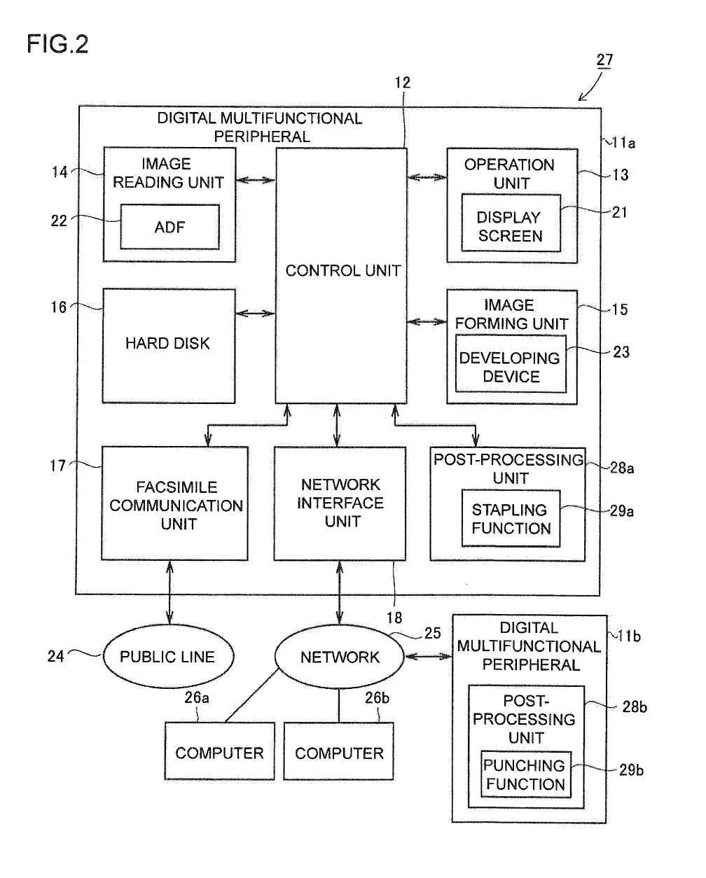

An embodiment of the present disclosure will be described below. First, the configuration of a digital multifunctional peripheral in the case where an image processing apparatus included in an image processing system according to an embodiment of the present disclosure is applied to the digital multifunctional peripheral will be described primarily. FIG. 1 schematically shows an appearance of the digital multifunctional peripheral. FIG. 2 is a block diagram showing the configuration of the image processing system, mainly showing the configuration of the digital multifunctional peripheral shown in FIG. 1.

Referring to FIGS. 1 and 2, first, the configuration of the digital multifunctional peripheral 1 la included in the image processing system 27 according to an embodiment of the present disclosure will be described. The digital multifunctional peripheral 11a includes: a control unit 12; an operation unit 13; an image reading unit 14; an image forming unit 15; a hard disk 16; a facsimile communication unit 17; a network interface unit 18 for connecting with a network 25; and a post-processing device 28a. The control unit 12 is responsible for overall control of the digital multifunctional peripheral 11a. The operation unit 13 includes a display screen 21 for displaying information originated from the digital multifunctional peripheral 11a side and content input by a user. The operation unit 13 causes a user to set image forming conditions, such as the number of copies and gradation, and to turn the power on or off The image reading unit 14 includes an auto document feeder (ADF) 22 which automatically feeds a document that has been set, to a reading section. The image reading unit 14 reads an image of a document. The image forming unit 15 includes a developing device 23. The image forming unit 15 forms an image on the basis of image data of the document which has been read or on the basis of image data received via the network 25. The hard disk 16 stores, among others, the image data received, and the image forming conditions input. The facsimile communication unit 17, which is connected to a public line 24, performs facsimile transmission and reception. The post-processing device 28a includes, as a post-processing function, a stapling function 29a of stapling a plurality of sheets, with images formed thereon by the image forming unit 15, together. Although the digital multifunctional peripheral 11a further includes a dynamic random access memory (DRAM) to and from which image data is written and read, and other components, the illustration and description thereof will be omitted. The arrows shown in FIG. 2 indicate flows of control signals as well as data related to control and images.

The digital multifunctional peripheral 11a operates as a copier by forming an image in the image forming unit 15 using the image data of the document read by the image reading unit 14. The digital multifunctional peripheral 11a operates as a printer by forming an image and printing the image on a sheet of paper in the image forming unit 15 using image data received from a computer 26a, 26b, connected to the network 25, via the network interface unit 18. That is, the image forming unit 15 operates as the printing unit which prints a requested image. Further, the digital multifunctional peripheral 11a operates as a facsimile machine by forming an image in the image forming unit 15 via the DRAM using the image data received from the public line 24 through the facsimile communication unit 17, or by transmitting the image data of the document read by the image reading unit 14 to the public line 24 through the facsimile communication unit 17. As such, the digital multifunctional peripheral 11a has a plurality of functions related to image processing, such as a copying function, function as a printer, facsimile function, etc. The digital multifunctional peripheral 11a further has a function enabling detailed settings for each of the above functions.

The image processing system 27 according to an embodiment of the present disclosure includes, in addition to the digital multifunctional peripheral 11a, another digital multifunctional peripheral 11b having a configuration similar to that of the digital multifunctional peripheral 11a except for the post-processing device 28a, and a plurality of computers 26a, 26b. Specifically, the image processing system 27 includes: the digital multifunctional peripheral 11a which has the above configuration; the digital multifunctional peripheral 11b which has a post-processing device 28b including, not the stapling function 29a, but a punching function 29b as a post-processing function; and the plurality of computers 26a, 26b which are each connected to the digital multifunctional peripherals 11a and 11b via the network 25. In the present embodiment, two computers 26a and 26b are shown as the plurality of computers. Each computer 26a, 26b is able to issue a print request to the digital multifunctional peripherals 11a, 11b via the network 25 for printing. The digital multifunctional peripheral 11a can use the stapling function 29a included in the post-processing device 28a to staple a plurality of sheets with images formed thereon for output. The digital multifunctional peripheral 11b can use the punching function 29b included in the post-processing device 28b to punch a plurality of sheets with images formed thereon, at a prescribed portion near the edges thereof, so that the punched holes penetrate the sheets in the thickness direction thereof The digital multifunctional peripherals 11a, 11b and the computers 26a, 26b may be connected via wire using a local area network (LAN) cable or the like, or they may be connected wirelessly. Yet another digital multifunctional peripheral or a server may be connected in the network 25.

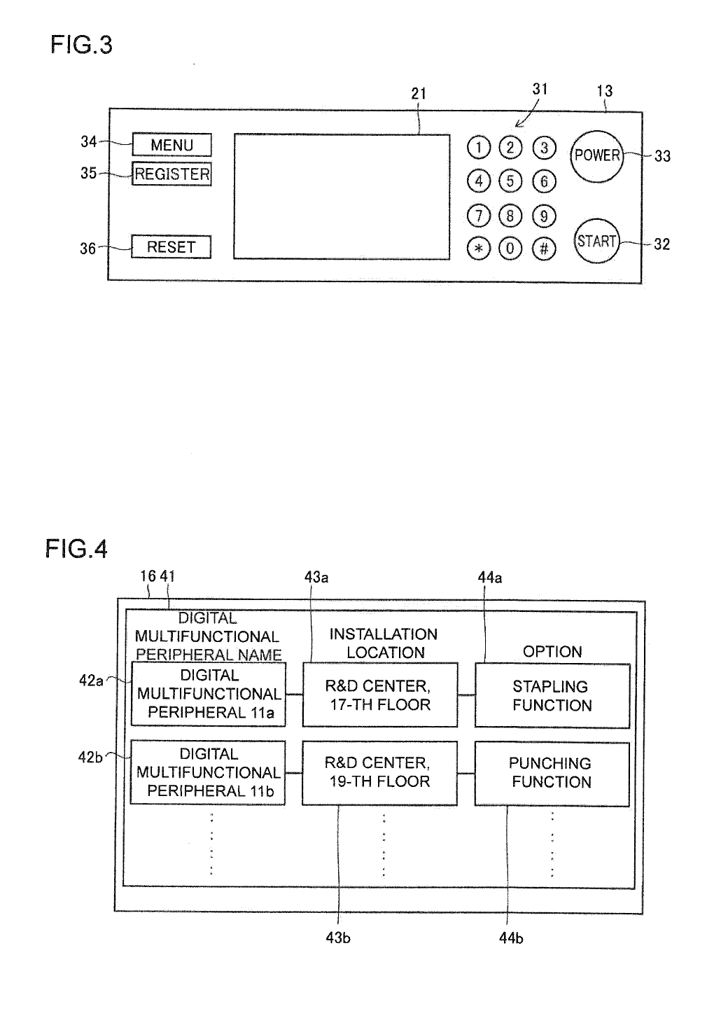

The configuration of the operation unit 13 described above will now be described in more detail. FIG. 3 shows a schematic configuration of the operation unit 13. Referring to FIG. 3, the operation unit 13 includes: a numeric keypad 31 including the numeric keys 0 to 9 for inputting the number of copies and the like, and symbol keys “*” and “#”; a start key 32 for instructing to start printing or facsimile transmission; a power key 33 for turning the digital multifunctional peripheral 11a on or off; a menu key 34 for selecting a function such as the printing or copying function included in the digital multifunctional peripheral 11a; a register key 35 for registering various image forming conditions as well as users; a reset key 36 for canceling the content of instruction input by a user using the numeric keypad 31 or the like; and the display screen 21 described above. The display screen 21 has a liquid crystal touch panel function, and allows a user to press the screen with his/her finger(s) to input the image forming conditions and select the functions via the display screen 21 as well.

The content of data stored in the hard disk 16 described above will now be described. Referring to FIG. 4, the hard disk 16 has a data storage area 41 which stores data on the digital multifunctional peripherals 11a and 11b. Specifically, data 42a and 42b are stored as the names of the respective digital multifunctional peripherals 11a and 11b connected by the network 25. Data 43a and 43b on the installation locations of the respective digital multifunctional peripherals 11a and 11b, and data 44a and 44b on the optional functions included in the respective digital multifunctional peripherals 11a and 11b are also stored. The data 42a on the name of the digital multifunctional peripheral 11a is stored in association with the data 43a on the installation location of the digital multifunctional peripheral 11a and the data 44a on the optional function included in the digital multifunctional peripheral 11a. The data 42b on the name of the digital multifunctional peripheral 11b is stored in association with the data 43b on the installation location of the digital multifunctional peripheral 11b and the data 44b on the optional function included in the digital multifunctional peripheral 11b. Here, the hard disk 16 operates as the storing unit which stores the data 42a and the like.

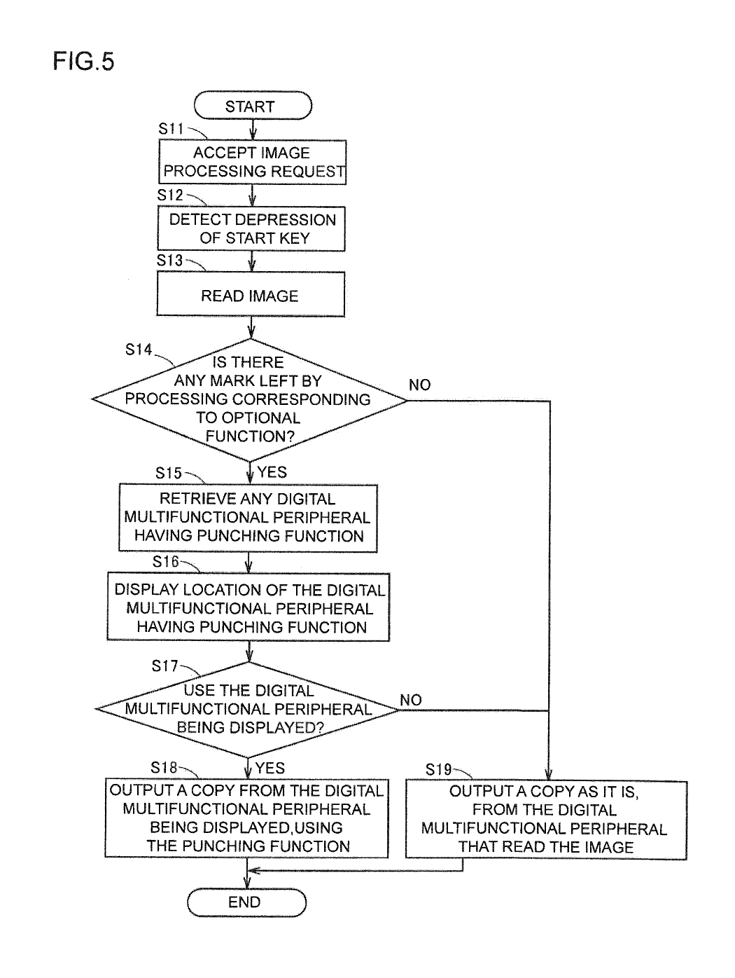

A description will now be made about the case of performing image processing using the image processing system 27 according to an embodiment of the present disclosure which includes the digital multifunctional peripherals 11a and 11b. FIG. 5 is a flowchart illustrating a process flow in the case where image processing is performed using the image processing system 27. It is here assumed that a user uses the digital multifunctional peripheral 11a to copy a document having holes punched near the edge thereof and he/she wishes that the copy is punched in the same manner as the original before being output.

Referring to FIG. 5 and so on, the digital multifunctional peripheral 11a first accepts an image processing request input from a user (step S11 in FIG. 5; the term “step” will be omitted hereinafter). The user sets one or more documents in the ADF 22 and inputs the content of image processing request, such as the number of copies and image density, using the numeric keypad 31 and the menu key 34 in the operation unit 13, following the display on the display screen 21.

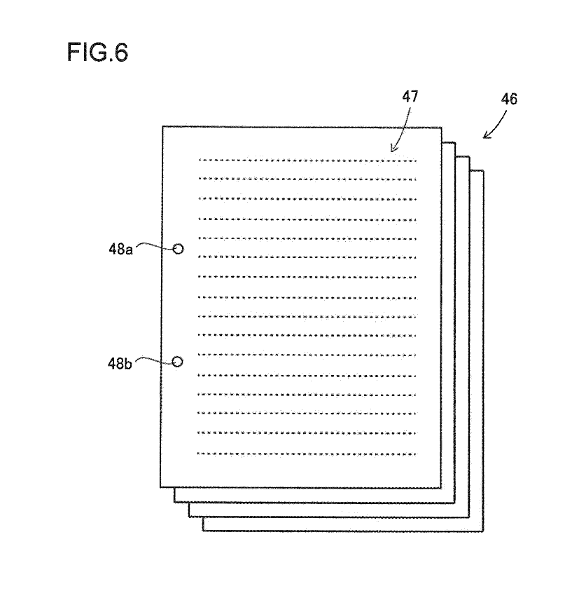

Here, documents set in the ADF 22 will be described. Referring to FIG. 6 showing the documents set in the ADF 22, each document 46 as an original has a character area 47, containing characters, located roughly in the center of the document 46. Each document 46 also has two punched holes 48a and 48b, which are round holes punched near the edge on the left side of the document 46, spaced apart from each other in a so-called longitudinal direction. For example, a user has punched the punched holes 48a, 48b using a punch. The documents 46 each have these punched holes 48a, 48b located at almost the same positions.

Thereafter, a user depresses the start key 32 to instruct to start image processing. When the digital multifunctional peripheral 11a detects that the start key 32 has been depressed (S12), it reads an image of a document 46 by the image reading unit 14 (S13). In this case, the documents 46 set in the ADF 22 are fed one by one to the image reading section, which in turn reads the images of the documents 46 on a sheet-by-sheet basis.

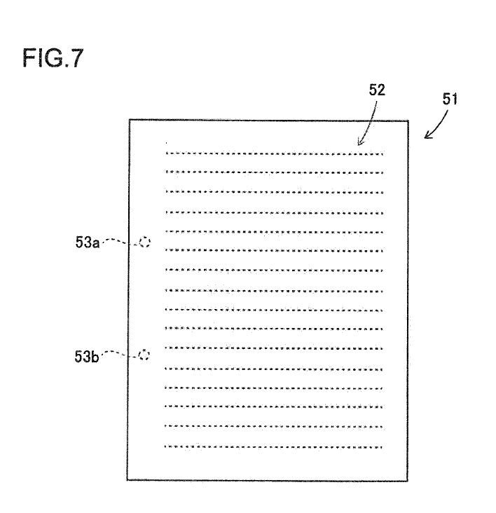

Next, the digital multifunctional peripheral 11a determines whether the read image has any mark left by processing corresponding to an optional function (S14). As used herein, the “mark left by processing corresponding to an optional function” refers to a mark which was left by certain processing and which can be reproduced by a corresponding optional function. FIG. 7 shows an image read by the image reading unit 14. Referring to FIG. 7, the image 51 read by the image reading unit 14 has a character area 52 containing characters, corresponding to the character area 47 in the document 46, and round hole marks 53a and 53b, corresponding respectively to the punched holes 48a and 48b formed in the document 46. The images 51 of the rest of the read documents 46 similarly have round hole marks 53a and 53b corresponding to the punched holes 48a and 48b. The marks 53a and 53b can be recognized as the marks that have been left by processing corresponding to an optional function, i.e. the punch hole marks corresponding to the punched holes 48a and 48b, on the basis of the fact that they appear in the same positions in the plurality of sheets, and also on the basis of the sizes and positions thereof. It should be noted that the marks 53a, 53b corresponding to the punched holes 48a, 48b are indicated by the broken lines in FIG. 7 for ease of understanding.

Here, the digital multifunctional peripheral 11a determines that the image 51 of the read document 46 has marks 53a, 53b corresponding to punched holes 48a, 48b (YES in S14). Here, the control unit 12 and some other components operate as the determination unit. Then, the digital multifunctional peripheral 11a retrieves any digital multifunctional peripheral, including itself, that includes a post-processing device having a punching function, from the network 25 (S15). Specifically, the digital multifunctional peripheral 11a searches the data 42a and the like stored in the data storage area 41 in the hard disk 16 included in the digital multifunctional peripheral 11a. Here, the control unit 12 and some other components operate as the retrieving unit.

In this case, the digital multifunctional peripheral 11a retrieves, on the basis of the data 44b, the data 42b on the name of the digital multifunctional peripheral 11b which includes the post-processing device 28b including the punching function 29b. The digital multifunctional peripheral 11a then notifies that there is the digital multifunctional peripheral 11b including the post-processing device 28b having the punching function 29b on the network 25, and that the digital multifunctional peripheral 11b is located in “the R&D center, on the 19-th floor”, from the data 43b on the installation location of the digital multifunctional peripheral 11b. In this case, the information is displayed on the display screen 21 in the operation unit 13 (S16). Here, the operation unit 13 and some other components operate as the notification unit. It should be noted that the digital multifunctional peripheral 11a is not retrieved because, although it includes the post-processing device 28a having the stapling function 29a, it does not include a post-processing device having the punching function. When displaying the installation location of the digital multifunctional peripheral 11b, the digital multifunctional peripheral 11a also makes an inquiry, on the display screen 21, about whether to use the digital multifunctional peripheral 11b being displayed (S17).

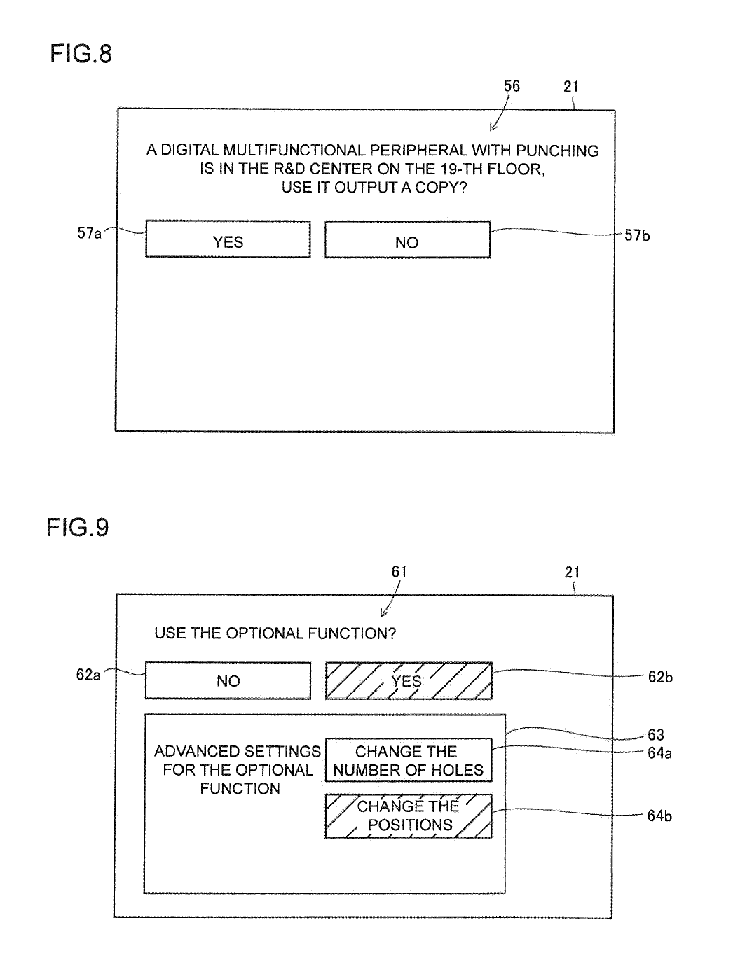

FIG. 8 shows an example of the display screen 21 of the operation unit 13 in this case. Referring to FIG. 8, the following are displayed on the display screen 21 of the operation unit 13: a message 56 reading that “A digital multifunctional peripheral with punching function is in the R&D center on the 19-th floor. Use it to output a copy?”; a selection key 57a labeled “YES” for approving the output from the digital multifunctional peripheral 11b; and a selection key 57b labeled “NO” for withholding the output therefrom.

The above display on the display screen 21 allows the user to know that the digital multifunctional peripheral 11a does not include a post-processing device having the punching function, and that the digital multifunctional peripheral 11b installed in a different place includes the post-processing device 28b having the punching function 29b. Further, with the above display on the display screen 21, the digital multifunctional peripheral 11a can inquire the user whether to perform image processing using the digital multifunctional peripheral 11b being displayed, thereby prompting the user to do so. Here, the control unit 12 operates as the control unit which performs control to prompt the image processing by the digital multifunctional peripheral 11b including the optional function corresponding to the marks 53a, 53b.

Here, assume that the user depresses the selection key 57a labeled “YES”. When the digital multifunctional peripheral 11a detects that the user has depressed the selection key 57a (YES in S17), the digital multifunctional peripheral 11a transmits the data of the read image to the digital multifunctional peripheral 11b via the network 25. Then, in the digital multifunctional peripheral 11b, an image is formed on a sheet and the sheet is punched using the punching function 29b included in the post-processing device 28b and then output (S18). In this manner, the image processing is performed by the image processing system 27. It should be noted that the user goes to the installation location of the digital multifunctional peripheral 11b on the 19-th floor of the R&D center, and obtains the copy that has undergone the punching process.

On the other hand, assume that the user depresses the selection key 57b labeled “NO”. When the digital multifunctional peripheral 11a detects that the user has depressed the selection key 57b (NO in S17), the digital multifunctional peripheral 11a performs image processing and outputs a copy as it is, with no hole punched by a punching function (S19). That is, a copy is made using the read image and output. In this case, the copy with no punched holes is output according to the user request, i.e. the request based on the selection of “NO”. It should be noted that when the digital multifunctional peripheral 11a determines in S14 that there is no mark left by processing corresponding to an optional function (NO in S14) as well, the digital multifunctional peripheral 11a performs image processing and outputs a copy as it is.

According to the image processing system 27 described above, it is readily possible to find a digital multifunctional peripheral that includes the optional function capable of performing printing and/or post-processing requested by a user, from among the plurality of digital multifunctional peripherals 11a, 11b connected through the network 25. This makes it possible to perform the printing and/or post-processing requested by a user, using the digital multifunctional peripheral that is connected through the network 25 and that includes the optional function capable of performing the printing and/or post-processing requested by the user. Accordingly, the image processing system 27 described above can perform the printing and/or post-processing requested by a user, at a more sophisticated level.

Further, in this case, the control unit is provided which performs control to prompt execution of image processing by the digital multifunctional peripheral 11b including the optional function corresponding to the marks 53a, 53b, following the notification made by the notification unit, i.e. the display on the display screen 21 of the operation unit 13. This ensures that printing and/or post-processing in more conformity with the user request can be performed at a sophisticated level.

Further, in this case, the hard disk 16 stores data concerning the installation locations of the digital multifunctional peripherals 11a, 11b, and the display screen 21 of the operation unit 13 displays the information about the place where the digital multifunctional peripheral 11b including the optional function is located. This allows the user to readily find the location of the digital multifunctional peripheral 11b from which a copy can be output as requested by the user. Accordingly, the user can use the displayed information as an important clue when the user goes to the place where the digital multifunctional peripheral 11b including the optional function is located so as to cause it to perform image processing, or when the user goes to that place so as to collect the copy output therefrom after the image processing.

Further, in this case, the data is displayed on the display screen 21, allowing the user to check the data visually.

In the above embodiment, when it is determined that there are staple marks left, rather than the punched hole marks, then the installation location of the digital multifunctional peripheral 11a and other information are displayed.

Further, when the retrieving unit cannot retrieve information about the image processing apparatus including the optional function corresponding to the marks, the notification unit may make a notification to that effect. This can prompt the user to change the printing and/or post-processing that the user has requested.

In the above embodiment, it may be configured such that, when it is determined that there is a mark left by processing corresponding to an optional function and when the optional function is to be used, the user is allowed to make new setting for the optional function.

FIG. 9 shows, by way of example, the display screen 21 of the operation unit 13 in the case of prompting an input of new setting for an optional function. Referring to FIG. 9, the following are displayed on the display screen 21 of the operation unit 13: a message 61 asking “Use the optional function?”; a selection key 62a labeled “NO” selected when not using the optional function; a selection key 62b labeled “YES” selected when using the optional function; a window 63 displaying advanced settings for the optional function; and a selection key 64a labeled “Change the number of holes” for changing the number of holes to be punched and a selection key 64b labeled “Change the positions” for changing the positions to be punched, as the advanced settings for the optional function. When the punching function is used to punch holes, the above-described display and input screen allows a user to make advanced settings by changing the number of or the positions of punched holes, ensuring that the image processing can be carried out in more conformity with the user request. In FIG. 9, the state where the user has depressed and selected the selection key 62b labeled “YES” and the selection key 64b labeled “Change the positions” is indicated by hatching.

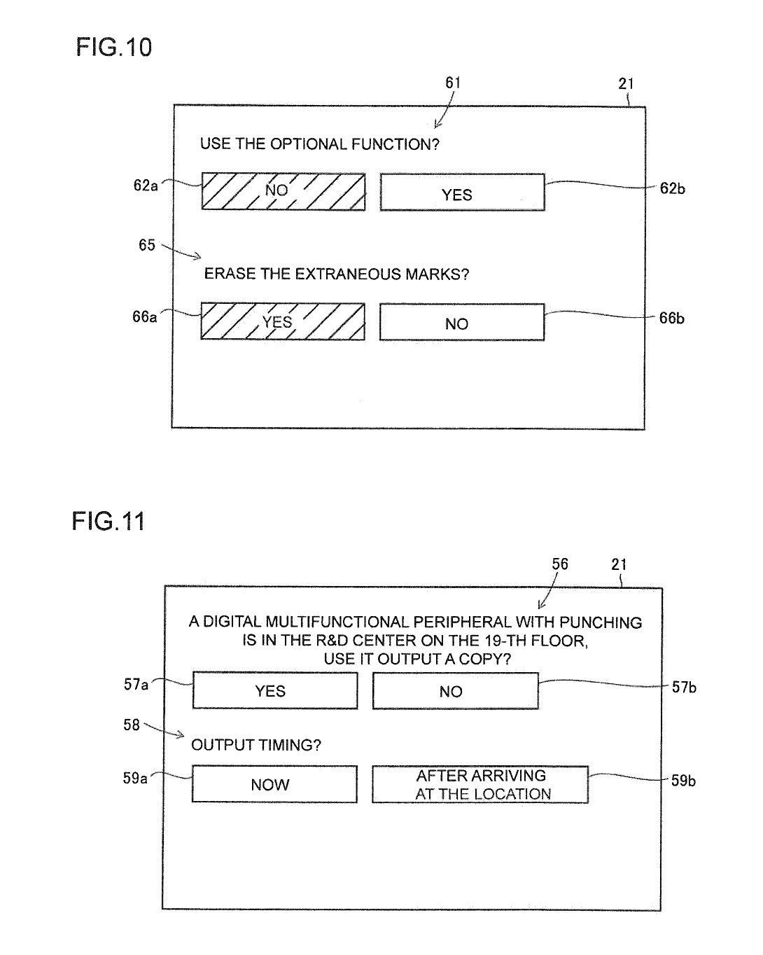

Further, in the above embodiment, it may be configured such that, when it is determined that there are punched hole marks, image processing for erasing the punched hole marks can be set. FIG. 10 shows an exemplary display screen of the operation unit in this case. Referring to FIG. 10, the following are displayed on the display screen 21 of the operation unit 13: a message 61 asking “Use the optional function?”; a selection key 62a labeled “NO” selected when not using the optional function; a selection key 62b labeled “YES” selected when using the optional function; a message 65 asking “Erase the extraneous marks?”; a selection key 66a labeled “YES” for erasing the marks; and a selection key 66b labeled “NO” for refraining from erasing the marks. When a document with punched holes is read, the above-described display and input screen ensures that image processing can be carried out in more conformity with the user request. It should be noted that when no punching function is used, a copy of the read image can be output from the digital multifunctional peripheral 11a that has read the image. In FIG. 10, the state where the user has depressed and selected the selection key 62a labeled “NO” and the selection key 66a labeled “YES” is indicated by hatching.

Further, in the above embodiment, it may be configured to allow a user to set the timing of output from the digital multifunctional peripheral 11b when the user has selected the output therefrom in S17. FIG. 11 shows an exemplary display screen of the operation unit in this case. Referring to FIG. 11, the following are displayed on the display screen 21 of the operation unit 13: a message 56 reading that “A digital multifunctional peripheral with punching function is in the R&D center on the 19-th floor. Use it to output a copy?”; a selection key 57a labeled “YES” for approving the output from the digital multifunctional peripheral 11b; a selection key 57b labeled “NO” for withholding the output therefrom; a message 58 asking “Output timing?”; a selection key 59a labeled “Now” for immediately outputting the copy from the digital multifunctional peripheral 11b; and a selection key 59b labeled “After arriving at the location” for outputting the copy by depressing the start key on the digital multifunctional peripheral 11b. With this configuration, when the user selects the output from the digital multifunctional peripheral 11b, the user can further depress one of the selection keys 59a and 59b to output a copy from the digital multifunctional peripheral 11b at the timing more convenient for the user.

While the stapling function and the punching function were included as the optional functions in the respective post-processing devices in the above embodiment, the optional functions are not limited thereto. A post-processing device may be configured to include at least one of the stapling, punching, imposition, and bookbinding functions. Here, the imposition function refers to the function of arranging a plurality of pages per sheet in such a manner that the pages appear in the correct reading order after printing, folding, and binding. Further, an image processing system may be configured to include a post-processing device having a plurality of optional functions. The optional function may, of course, be one that is not included in a post-processing device. In the case where two or more digital multifunctional peripherals include the optional function that corresponds to the mark left by certain processing, those digital multifunctional peripherals may all be displayed. This allows a user to select a more closely located apparatus from among them, leading to improved convenience.

Further, in the above embodiment, the notification unit includes the display unit which displays information regarding the digital multifunctional peripherals. The configuration of the notification unit, however, is not limited thereto. For example, the notification unit may be configured to make a notification with sound instead of, or in addition to, the display on the display unit.

It should be noted that, in the above embodiment, the data stored in the hard disk in each digital multifunctional peripheral may be updated periodically. With this configuration, the retrieval by the retrieving unit can be carried out on the basis of more recent data about the image processing apparatuses connected through the network. Needless to say, the data may be stored into the hard disk with manual input by a user.

Further, in the above embodiment, the processing by the determination unit, the retrieving unit, and the notification unit may be applied to the case of performing settings for printing, for example, besides settings for the optional functions included in the post-processing devices. Further, it may be applied to the case of performing printing alone, and also to the case of performing post-processing alone.

While the installation location of the digital multifunctional peripheral was displayed in the above embodiment, the display is not limited thereto. For example, the name of the digital multifunctional peripheral alone may be displayed. This can address the case where a user can locate the digital multifunctional peripheral when he/she recognizes its name.

Further, in the above embodiment, the user was prompted to perform image processing using the digital multifunctional peripheral having the optional function, through the display on the display screen. The configuration, however, is not limited thereto; only the name of the digital multifunctional peripheral having the optional function may be displayed. This enables the user to go to the installation location of the digital multifunctional peripheral on the basis of the displayed name, and use the digital multifunctional peripheral to perform image processing as he/she wishes.

In the above embodiment, all that is needed is that at least one of the image processing apparatuses included in the image processing system includes: a storing unit configured to store data on each of the image processing apparatuses including data on an optional function included in the image processing apparatus; an image reading unit configured to read an image of a document; a determination unit configured to determine whether the image read by the image reading unit has any mark left by processing corresponding to an optional function; a retrieving unit operable, in response to determination by the determination unit that the image has the mark, to retrieve from the storing unit the data on the image processing apparatus that includes the optional function corresponding to the mark; and a notification unit configured to notify the data on the image processing apparatus that includes the optional function, retrieved by the retrieving unit.

It should be understood that the embodiment disclosed herein is illustrative and non-restrictive in every respect. The scope of the present disclosure is defined by the terms of the claims, rather than the description above, and is intended to include any modifications within the scope and meaning equivalent to the terms of the claims.

The image processing system according to the present disclosure is applicable particularly advantageously to the case where the printing or post-processing requested by a user is required to be achieved at a more sophisticated level.

What is claimed is:

1. An image processing system having a plurality of image processing apparatuses connected via a network, at least one of the image processing apparatuses comprising:
a storing unit configured to store data on each of the image processing apparatuses including data on an optional function included in the image processing apparatus;
an image reading unit configured to read an image of a document;
a determination unit configured to determine whether the image read by the image reading unit has any mark left by processing corresponding to an optional function;
a retrieving unit operable, in response to determination by the determination unit that the image has the mark, to retrieve from the storing unit the data on the image processing apparatus that includes the optional function corresponding to the mark; and
a notification unit configured to notify the data on the image processing apparatus that includes the optional function, retrieved by the retrieving unit.

2. The image processing system according to claim 1, wherein the optional function includes at least one of a stapling function, a punching function, an imposition function, and a bookbinding function.

3. The image processing system according to claim 1, wherein the at least one image processing apparatus further comprises a control unit configured to perform control, following the notification made by the notification unit, to prompt a user to perform image processing using the image processing apparatus that includes the optional function corresponding to the mark.

4. The image processing system according to claim 1, wherein
the storing unit configured to store data related to locations where the image processing apparatuses have been installed, and
the notification unit configured to notify information about the place where the image processing apparatus that includes the optional function is located.

5. The image processing system according to claim 1, wherein the notification unit includes a display unit configured to display information about the image processing apparatus that includes the optional function.

6. The image processing system according to claim 1, wherein in the case where the retrieving unit has failed to retrieve the data on the image processing apparatus that includes the optional function corresponding to the mark, the notification unit makes a notification to that effect.
